(19) United States
(12) Patent Application Publication
(10) Pub. No.: US 2011/0203889 A1
(43) Pub. Date: Aug. 25, 2011

(54) ASSEMBLY AND DISASSEMBLY-TYPE DAMPING FORCE ADJUSTABLE SHOCK ABSORBER

(76) Inventor: Tae Woong Eom, Gunpo-si (KR)

(21) Appl. No.: 13/024,374

(22) Filed: Feb. 10, 2011

(30) Foreign Application Priority Data
Feb. 22, 2010 (KR) 10-2010-0015640

(51) Int. Cl. F16F 9/34

(52) U.S. Cl. 188/322.15

(57) ABSTRACT

An assembly and disassembly-type damping force adjustable shock absorber is provided comprising a cylinder casing, an upper cap and a lower cap, a bottom valve body mounted on the lower cap, a rod inserted into the upper cap, and a piston valve body disposed on an end of the rod, wherein the piston valve body faces the bottom valve body, wherein the piston valve body determines a flow direction of the working fluid between the upper chamber and the lower chamber when the rod is expanded and contracted.

### CROSS-REFERENCE TO RELATED APPLICATION

This application claims priority to Korean patent application No. 10-2010-0015640 filed on Feb. 22, 2010, the entire disclosure of which is incorporated by reference herein.

### BACKGROUND

1. Technical Field

Embodiments of the present invention relate to a damping force adjustable shock absorber and, more particularly, to an assembly and disassembly-type damping force adjustable shock absorber.

2. Discussion of the Related Art

In general, a shock absorber for improving riding comfort and increasing rotational power is mounted on the suspension apparatus of a vehicle. The shock absorber has a spring that prevents a shock generated due to a difference in the height of a road surface by repeatedly rebounding up and down.

Shock absorbers may be divided into oil shock absorbers using oil as a working fluid to compensate for the expansion and contraction of the spring and gas shock absorbers using gas as a working fluid. The oil shock absorber was first developed and is advantageous in that it has good riding comfort and enables mass production. The oil shock absorber, however, has a low damping force because oil is not sufficiently supplemented when a high-speed piston is operated. The gas shock absorber was developed to alleviate the disadvantage of the oil shock absorber. The gas shock absorber has a stable damping force, long durability, a good surface traction of a tire, and excellent riding comfort and rotational power.

The conventional shock absorber has a limit to the control of damping force because damping is performed only through a piston valve. Furthermore, since such a control apparatus is exposed outside the shock absorber, the entire construction of the shock absorber is complicated and there is a difficulty in mounting the shock absorber in a narrow installation space.

The conventional shock absorber cannot be used in other vehicles because the strength of a damping force to damp an external force is set when the shock absorber is first shipped. Accordingly, for example, several kinds of shock absorbers having different damping forces according to the types of vehicles may have to be fabricated.

The conventional shock absorber mounted on a vehicle commonly has some displacement in the mounting position according to a suspension apparatus or the shape of a vehicle body frame. Accordingly, there is a problem in that a mounting bracket is separately fabricated according to the displacement.

The interval (height) between the vehicle body and the suspension apparatus is different because the weight or tolerable weight of the vehicle body is different according to the type of the vehicle. Accordingly, for example, a shock absorber having a different length according to the type of the vehicle may have to be fabricated.

When a shock absorber that cannot adjust a flexural strength and a compressive force is mounted on a different type of a vehicle, it is difficult to mount the shock absorber and there occurs a difference in the weight and damping force. Accordingly, riding comfort and the basic function of the shock absorber are deteriorated.

### SUMMARY

Embodiments of the present invention provide a damping force-adjustable shock absorber, which can be mounted by controlling a damping force according to the tensile strength and compressive force of the shock absorber, thereby enabling a damping force to be effectively controlled, simplifying the structure, and easy mounting irrespective of the types of vehicles.

Embodiments of the present invention provide a shock absorber having adjustable damping force, in which an installation angle of the shock absorber, slightly varying according to the type of the vehicle, and an installation length of the shock absorber, having a difference, can be arbitrarily adjusted, so that the shock absorber can be applied to any type of a vehicle.

According to an embodiment of the present invention, there is provided an assembly and disassembly-type damping force adjustable shock absorber comprising a cylinder casing having a double tube structure of an inner cylinder and an outer cylinder, an upper cap and a lower cap closing upper and lower portions, respectively, of the cylinder casing, a bottom valve body mounted on the lower cap, wherein the bottom valve body is configured so that a working fluid flows between the inner cylinder and the outer cylinder via a first passage when a compression operation is performed and via a second passage when an extension operation is performed, wherein the first passage and the second passage are different from each other, and configured so that a damping force is adjusted by a compression damping force control means mounted on the lower cap through a first bypass passage formed in a center of the bottom valve body, a rod inserted into the upper cap while maintaining airtightness, wherein an end of the rod is extended into the inner cylinder and has a second bypass passage for connecting an upper chamber and a lower chamber, wherein a tensile strength adjustment means for adjusting a degree of opening and shutting of the second bypass passage is provided in a length direction, and a piston valve body disposed on an end of the rod, wherein the piston valve body faces the bottom valve body, wherein the piston valve body determines a flow direction of the working fluid between the upper chamber and the lower chamber when the rod is expanded and contracted.

According to an embodiment of the present invention, there is provided a shock absorber comprising a cylinder casing having an inner cylinder and an outer cylinder arranged at an outside of the inner cylinder, an upper cap and a lower cap closing upper and lower portions, respectively, of the cylinder casing, wherein a compression damping force control means is mounted on the lower cap, a bottom valve body disposed on the lower cap, wherein the bottom valve body is configured so that a working fluid flows between the inner cylinder and the outer cylinder via a first passage when a compression operation is performed and via a second passage when an extension operation is performed and configured so that a damping force is adjusted by the compression damping force control means through a first bypass passage formed in a center of the bottom valve body, a rod airtightly inserted into the upper cap, wherein an end of the rod is extended into the inner cylinder, and a piston valve body that is disposed on an end of the rod and faces the bottom valve body, wherein the piston valve body having a second bypass passage that connects an upper chamber and a lower chamber included in the inner cylinder with each other, wherein the piston valve body determines a flow direction of the working fluid between the upper chamber and the lower chamber when the rod is expanded and contracted, and wherein the rod includes in a length direction a tensile strength adjustment means that adjusts a degree of opening and shutting of the second bypass passage.

### BRIEF DESCRIPTION OF THE DRAWINGS

The embodiments of the present invention will be more fully understood from the following detailed description taken in conjunction with the accompanying drawings in which:

FIG. 1 is a cross-sectional view illustrating the entire construction of a shock absorber according to an embodiment of the present invention;

FIG. 2 is an expanded view of a portion A in FIG. 1, which illustrates a state in which a bottom valve body is mounted on a lower cap according to an embodiment of the present invention;

FIG. 3 is an expanded view of a portion B in FIG. 1, which illustrates a state in which a piston valve body is mounted on a rod according to an embodiment of the present invention;

FIG. 4 is a photograph showing a state in which a strut mounting bracket is mounted according to an embodiment of the present invention;

FIG. 5A a cross-sectional view illustrating an operation of a shock absorber when the shock absorber is extended according to an embodiment of the present invention; and

FIG. 5B a cross-sectional view illustrating an operation of a shock absorber when the shock absorber is compressed according to an embodiment of the present invention.

### DETAILED DESCRIPTION OF THE EMBODIMENTS

Hereinafter, some embodiments of the present invention will be described in detail with reference to the accompanying drawings, wherein the same reference numerals may be used to denote the same or substantially the same reference numerals throughout the drawings and the specification.

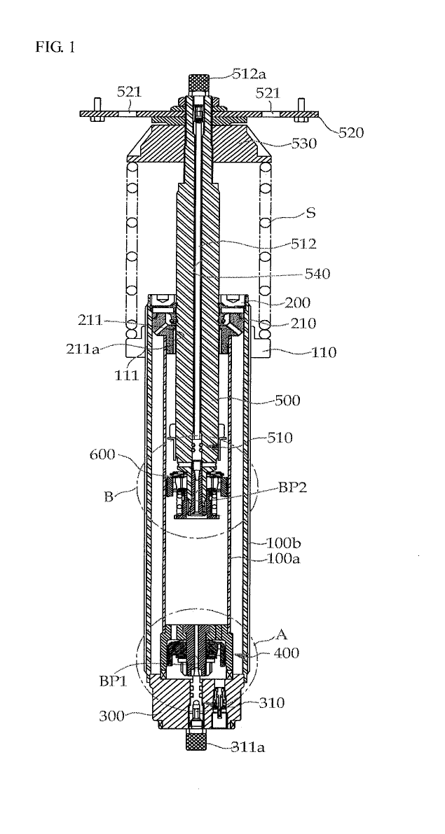

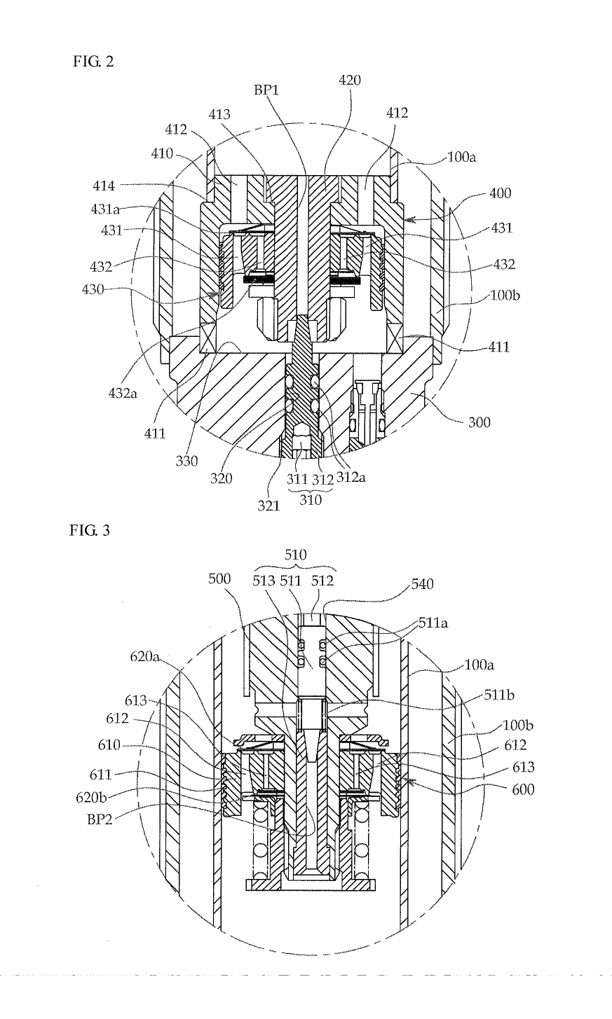

FIG. 1 is a cross-sectional view illustrating the entire construction of a shock absorber according to an embodiment of the present invention. FIG. 2 is an expanded view of a portion A in FIG. 1, which illustrates a state in which a bottom valve body is mounted on a lower cap according to an embodiment of the present invention. FIG. 3 is an expanded view of a portion B in FIG. 1, which illustrates a state in which a piston valve body is mounted on a rod according to an embodiment of the present invention.

A shock absorber according to an embodiment of the present invention includes a cylinder casing, an upper cap 200, a lower cap 300, a bottom valve body 400, a rod 500, and a piston valve body 600. The cylinder casing has a double tube structure so that it can be expanded and contracted in a length direction. The upper cap 200 and the lower cap 300 close both ends of the cylinder casing. A compressive force of the bottom valve body 400 is adjusted by a compression damping force control means 310 so that a damping force can be adjusted when the shock absorber is compressed. The bottom valve body 400 functions to move a working fluid through the double tube structure according to the expansion and contraction operations. The rod 500 is mounted on the cylinder casing and includes a tensile strength adjustment means 510 for adjusting a damping force upon expansion. The piston valve body 600 is attached to a bottom of the rod 500 and is configured to absorb a shock by the working fluid flowing between an upper chamber and a lower chamber.

The cylinder casing includes an inner cylinder 100a and an outer cylinder 100b. Each of the inner cylinder 100a and the outer cylinder 100b is fabricated in a hollow pipe shape and is filled with the working fluid. According to an embodiment, the working fluid may include oil, as commonly used in the shock absorber, or a gas, such as nitrogen.

The inner cylinder 100a and the outer cylinder 100b are configured not to be corroded by working oil and to have durability enough to withstand the weight of a suspension apparatus and a chassis. For anti-corrosion characteristics and improved durability, for example, according to an embodiment, the inner cylinder 100a and the outer cylinder 100b may be made of a metal material, such as stainless still. The surfaces of the inner cylinder 100a and the outer cylinder 100b are subjected to metal chromate plating followed by a surface treatment using a chemical, such as a chemical for lacquer processing of a metal surface (e.g., Nikkasan Lacque HW commercially available from NIHON KAGAKU SANGYO CO., LTD).

According to an embodiment, a buffer spring S may be further included between the outer cylinder 100b and the rod 500. The buffer spring S performs a mutual supplementary function for the damping action of the shock absorber. The buffer spring S has one end supported by an upper spring sheet 530 mounted on a top of the rod 500 and the other end supported by a lower spring sheet 110 mounted on an outer circumference of the outer cylinder 100b. The lower spring sheet 110 is fastened to a screw unit 111, formed in the outer cylinder 100b, in a screw-fastening manner. The total length of the shock absorber can be adjusted by the elasticity of the buffer spring S through control of the height of the lower spring sheet 110.

The upper cap 200 closes an upper end of the cylinder casing. The upper cap 200 includes a gap maintenance member 210 for maintaining a predetermined interval between the inner cylinder 100a and the outer cylinder 100b. The gap maintenance member 210 also has an airtight maintenance function.

A mounting hole 211 is formed to penetrate the center of the upper cap 200 and the gap maintenance member 210 so that the rod 500 is installed in the mounting hole 211. The mounting hole 211 includes a sealing portion 211a for preventing leakage of the working fluid when the rod 500 is operated.

The lower cap 300 closes a lower end of the cylinder casing, has an airtight maintenance function, and maintains a predetermined interval between the inner cylinder 100a and the outer cylinder 100b. The lower cap 300 includes the compression damping force control means 310 for controlling a damping force when the bottom valve body 400 is compressed.

As shown in FIGS. 1 and 2, the compression damping force control means 310 includes an adjustment unit 311 and a needle portion 312. The adjustment unit 311 is inserted into an adjustment hole 320 that penetrates the lower cap 300 to communicate with an inside of the lower cap 300. The needle portion 312 is fixed to the adjustment unit 311 and opens a first bypass passage BP1 of the bottom valve body 400. The adjustment unit 311 includes an adjustment handle 311a that outwardly extends from the lower cap 300 to be easily turned. One end of the needle portion 312 is fastened to a female screw unit 321 formed in the outside of the adjustment hole 320 so that the needle portion 312 can be moved in a length direction when the adjustment handle 311a is rotated, and the other end of the needle portion 312 is inserted into the cylinder casing and the first bypass passage BP1. According to an embodiment, the other end of the needle portion 312 inserted into the first bypass passage BP1 has a tapered shape so that the degree of opening and closing of the first bypass passage BP1 can be adjusted when the needle portion 312 is moved in the length direction. The needle portion 312 includes a plurality of multi-stage sealing portions 312a along an outer circumference to prevent the working fluid from leaking through the adjustment hole 320.

A valve body seat face 330 is formed on a top of the lower cap 300. The valve body seat face 330 is cut and formed in a circular plate shape which has a predetermined radius in the center of the lower cap 300. The bottom valve body 400 is mounted on the valve body seat face 330, thus maintaining an interval between the inner cylinder 100a and the outer cylinder 100b.

As shown in FIGS. 1 and 2, the bottom valve body 400 includes a valve body 410 having a vessel shape, a seam unit 420 disposed in the center of the valve body 410, and a suction/discharge valve body 430 that is disposed within the valve body 410 on the seam unit 420 and moves the working fluid according to the expansion and contraction operations of the rod 500. The first bypass passage BP1 is formed in the seam unit 420 so that the working fluid can be moved up and down the valve body 410. The degree of opening and closing of the first bypass passage BP1 is adjusted by the compression damping force control means 310.

The valve body 410 includes first oil holes 411 at an upper side of a vessel shape, wherein the first oil holes 411 are spaced apart from each other at a specific interval, and second oil holes 412 at a bottom of a vessel shape. A step portion 413 at which the seam unit 420 is disposed is formed at a center of a lower portion of the vessel shape. A step jaw 414 having a predetermined width is formed at an entire edge of a lower portion of a vessel shape.

In the valve body 410 formed as described above, the upper portion of the vessel shape is inserted into the valve body seat face 330, and the inner cylinder 100a is inserted into the step jaw 414. Accordingly, the working fluid flows into the valve body 410 via the second oil holes 412. Next, the working fluid is damped between the inner cylinder 100a and the outer cylinder 100b via the first oil holes 411.

The seam unit 420 is inserted into the valve body 410 through the step portion 413 and is configured to support the suction/discharge valve body 430. The first bypass passage BP1 is formed over the entire length of the seam unit 420. The first bypass passage BP1 connects the outer cylinder 100b with the inner cylinder 100a in a roundabout way, and the first bypass passage BP1 is used as a passage through which the working fluid is supplied. The degree of opening and closing of the first bypass passage BP1 is adjusted by the compression damping force control means 310 to control a damping force.

A bolt and a nut having the first bypass passage BP1 formed over the entire length can be used as the seam unit 420.

The suction/discharge valve body 430 switches a flow direction of the working fluid between the outer cylinder 100b and the inner cylinder 100a when the rod 500 is extended and compressed. The suction/discharge valve body 430 includes a first expansion and contraction passage 431 and a second expansion and contraction passage 432 that form a passage when the rod 500 is extended and compressed and communicate with the first oil holes 411 and the second oil holes 412.

The suction/discharge valve body 430 includes a first retainer 431a and a second retainer 432a that are resiliently supported so that a direction in which the working fluid flows through the first expansion and contraction passage 431 and the second expansion and contraction passage 432 is determined. The first retainer 431a opens and shuts the first expansion and contraction passage 431 so that the working fluid can be damped to an inside of the inner cylinder 100a only when the rod 500 is extended. The second retainer 432an opens and shuts the second expansion and contraction passage 432 so that the working fluid exits to an outside of the inner cylinder 100a only when the rod 500 is compressed.

As shown in FIGS. 1 and 3, the rod 500 penetrates the upper cap 200 and is inserted in the upper cap 200. An end of the rod 500 is mounted on the inner cylinder 100a to slide along a length direction of the inner cylinder 100a. A second bypass passage BP2 is formed at a lower portion of the rod 500 which is inserted into the inner cylinder 100a. The second bypass passage BP2 has a reversed “L” shape so that the working fluid flows up and down with respect to the piston valve body 600 attached to the end of the rod 500. The rod 500 includes the tensile strength adjustment means 510 for controlling the degree of opening and closing of the second bypass passage BP2.

The tensile strength adjustment means 510 includes an adjustment knob 512 that is mounted on a mounting hole 540 formed in a length direction of the rod 500 and communicates with the second bypass passage BP2, a needle portion 511 that is mounted on an end of the adjustment knob 512 and opens the second bypass passage BP2, and a tapered member 513 that is disposed in the second bypass passage BP2 and controls the degree of opening and closing of the needle portion 511. Sealing portions 511a for preventing the working fluid from leaking along the rod 500 are provided at an outer circumference of the needle portion 511. The sealing portions 511a are resiliently supported by an elastic spring 511b and obviate an operating gap. An end of the adjustment knob 512 is connected to the needle portion 511, and the other end of the adjustment know 512 includes an adjustment handle 512a at a front end protruding toward an upper end of the rod 500. The adjustment knob 512 is fastened to the mounting hole 540 in a screw-fastening manner. The tapered member 513 has a tubular member. An inner surface of the tapered member 513 coming in contact with the needle portion 511 is tapered.

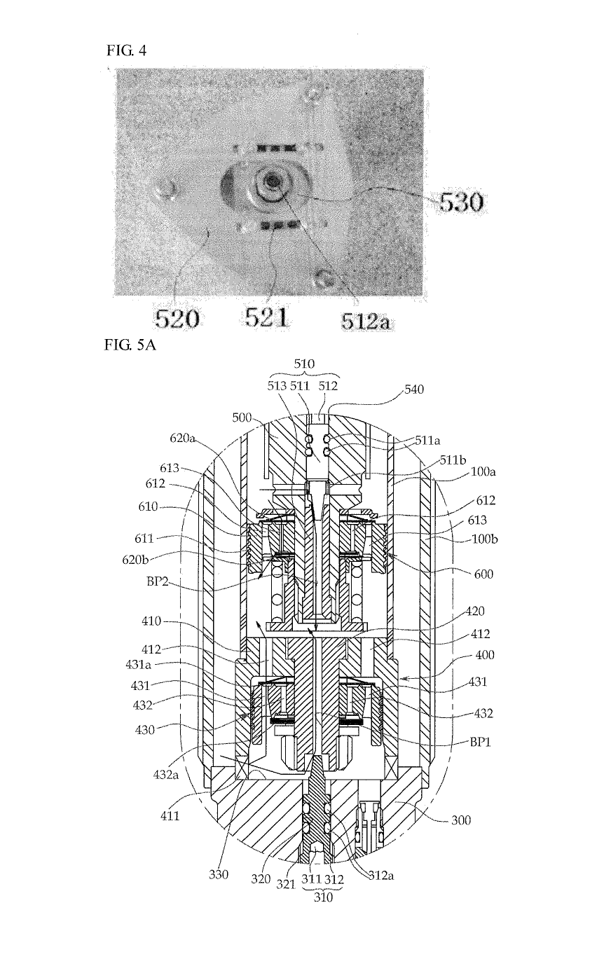

A strut mounting bracket 520 is provided at an upper end of the rod 500 so that the shock absorber can be mounted in the vehicle body. As shown in FIG. 4 illustrating a state in which the strut mounting bracket 520 is mounted, the strut mounting bracket 520 includes long holes 521 at an upper portion of the upper spring sheet 530 so that a camber angle can be easily adjusted. The long holes 521 compensate for an inclination or a deviated mounting position according to a mounting position of the shock absorber.

According to an embodiment, an outer circumference of the rod 500 may be subjected to hard chrome plating followed by an oxynitrocarburising process to improve lubricity and to protect the rod 500 from exposure to the working fluid or air or lubricity.

The piston valve body 600, as shown in FIG. 3, has a similar construction to the bottom valve body 400. The piston valve body 600 includes a main valve body 610 that is mounted on an end of the rod 500 and moves along an inside of the inner cylinder 100a and a pair of retainers 620a and 620b operating when the rod 500 operates.

A sealing portion 611 is provided at an outer circumference of the main valve body 610 and maintains airtightness with the inner cylinder 100a. The main valve body 610 includes third oil holes 612 and fourth oil holes 613 for connecting an upper chamber with a lower chamber, wherein the upper chamber and the lower chamber are partitioned by the main valve body 610 in the inner cylinder 100a.

The retainers 620a and 620b are disposed at upper and lower portions of the main valve body 610, respectively, and selectively open and close the third oil holes 612 and the fourth oil holes 613. The retainer 620a opens the third oil hole 612 when the rod 500 is compressed, and the retainer 620b opens the fourth oil hole 613 when the rod 500 is extended. The installation of the retainers 620a and 620b and opening and closing operations of the third oil holes 612 and the fourth oil holes 613 are known in the art.

According to an embodiment, a knuckle bracket (not shown) is mounted at an outer cylinder 100b of a lower portion of the shock absorber in a screw-fastening manner so that a height of the knuckle bracket can be adjusted.

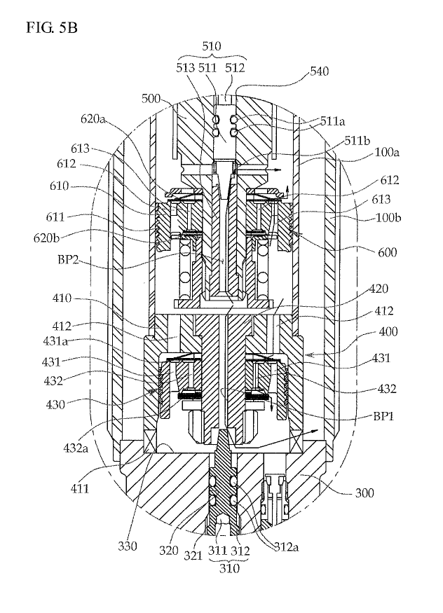

FIG. 5A a cross-sectional view illustrating major elements of a shock absorber according to an embodiment of the present invention, wherein an extending operation of the shock absorber will be described. Referring to FIG. 5A, arrows indicate the flow of a working fluid.

When the shock absorber is extended, for example, when the rod 500 rises, the pressure of an upper portion of the piston valve body 600 increases. By the increased pressure, the working fluid flows downwardly through the piston valve body 600 and performs a damping action. The damping action is performed while the working fluid flows downwardly through the fourth oil holes 613. When the second bypass passage BP2 is closed, the damping action is performed by only the elasticity of the retainer 620a for opening and closing the fourth oil holes 613. When the second bypass passage BP2 is opened by the tensile strength adjustment means 510 as shown in FIG. 5A, however, the working fluid is distributed through the second bypass passage BP2 by an amount corresponding to the opening degree of the second bypass passage BP2. Accordingly, a damping force applied to only the retainer 620a is distributed toward the second bypass passage BP2. Such a low damping force increases riding comfort.

When the first bypass passage BP1 is closed, the first expansion and contraction passage 431 of the bottom valve body 400 is opened, so that the working fluid flows into the inner cylinder 100a. The flux (that is, damping force) is determined by the strength of the first retainer 431a. If the first bypass passage BP1 is opened by the compression damping force control means 310, some of the working fluid detours through the first bypass passage BP1, thereby obtaining an effect of distributing the damping force distribution.

FIG. 5B is a cross-sectional view illustrating major elements of a shock absorber according to an embodiment of the present invention, wherein a compressing operation of the shock absorber will be described. Referring to FIG. 5B, arrows indicate the flow of a working fluid.

The compressing operation of the shock absorber is the same or substantially the same as the extending operation of the shock absorber except for the flow of the working fluid.

Some of the working fluid in the lower chamber is damped to the upper chamber through the fourth oil holes 613 according to an increase of the pressure. When the second bypass passage BP2 is opened by the tensile strength adjustment means 510 as shown in FIG. 5B, the working fluid is distributed through the second bypass passage BP2 by an amount corresponding to the opening degree of the second bypass passage BP2, thereby obtaining an effect of distributing the damping force.

The working fluid is damped to between the inner cylinder 100a and the outer cylinder 100b through the bottom valve body 400 at a lower side of the lower chamber. The working fluid passes through the second oil holes 412 to the second expansion and contraction passage 432 and then passes through the first oil holes 411. While the working fluid passes as described above, a damping effect is further increased through the distribution of the working fluid toward the first bypass passage BP1 as indicated by the arrows.

As described above, according to the embodiments of the present invention, a damping force can be adjusted by not only the piston valve body 600 but also the bottom valve body 400, and thus a construction capable of controlling an expansion and contraction damping force is provided in the shock absorber. Accordingly, the shock absorber can be easily installed in a vehicle with a simple structure.

The shock absorber may arbitrarily adjust a damping force according to the expansion and contraction of the shock absorber, which varies with the type of a vehicle, thus adjusting the damping force to be appropriate for various types of vehicles.

The height of the shock absorber may be adjusted according to the interval (height) between a suspension apparatus and a vehicle body.

Although an installation angle of the shock absorber is changed when the height of a vehicle is adjusted, the angle (for example, camber angle) may be easily adjusted by the long holes.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An assembly and disassembly-type damping force adjustable shock absorber comprising:
a cylinder casing having a double tube structure of an inner cylinder and an outer cylinder;
an upper cap and a lower cap closing upper and lower portions, respectively, of the cylinder casing;
a bottom valve body mounted on the lower cap, wherein the bottom valve body is configured so that a working fluid flows between the inner cylinder and the outer cylinder via a first passage when a compression operation is performed and via a second passage when an extension operation is performed, wherein the first passage and the second passage are different from each other, and configured so that a damping force is adjusted by a compression damping force control means mounted on the lower cap through a first bypass passage formed in a center of the bottom valve body;
a rod inserted into the upper cap while maintaining airtightness, wherein an end of the rod is extended into the inner cylinder and has a second bypass passage for connecting an upper chamber and a lower chamber, wherein a tensile strength adjustment means for adjusting a degree of opening and shutting of the second bypass passage is provided in a length direction; and
a piston valve body disposed on an end of the rod, wherein the piston valve body faces the bottom valve body, wherein the piston valve body determines a flow direction of the working fluid between the upper chamber and the lower chamber when the rod is expanded and contracted.

2. The shock absorber as claimed in claim 1, wherein
surfaces of the inner cylinder and the outer cylinder are subjected to metal chromate plating followed by a surface treatment using a chemical, and wherein
the rod is subjected to hard chrome plating followed by an oxynitrocarburising process.

3. The shock absorber as claimed in claim 1, wherein the compression damping force control means comprises:
an adjustment unit disposed in the lower cap, wherein a length of the adjustment unit is adjusted; and
a needle portion having a first end and a second end, wherein the first end is connected to the adjustment unit, and the second end is inserted into the lower cap and maintains airtightness, wherein the second end is resiliently supported to adjust a degree of opening and shutting of the first bypass passage.

4. The shock absorber as claimed in claim 1, wherein the bottom valve body comprises:
a valve body including first oil holes and second oil holes, wherein the working fluid flows between the inner cylinder and the outer cylinder;
a seam unit disposed in a center of the valve body, wherein the first bypass passage is formed in a center of the seam unit; and
a suction/discharge valve body that is disposed in the valve body and fixed to the seam unit, wherein the suction/discharge valve body opens and closes a first expansion and contraction passage and a second expansion and contraction passage 432 to selectively communicate with the first oil holes and the second oil holes according to expansion and contraction operations of the rod.

5. The shock absorber as claimed in claim 1, wherein long holes are formed in a strut mounting bracket mounted on an upper end of the rod, wherein the long holes adjust a fastening position according to a controlled position of a camber angle.

6. The shock absorber as claimed in claim 1, wherein the tensile strength adjustment means comprises:
a needle portion resiliently supported by and disposed in the rod, wherein the needle portion maintains airtightness and adjusts a degree of opening and closing of the second bypass passage;
an adjustment knob screwed to the rod, wherein the adjustment knob moves the needle portion in a length direction, and wherein the adjustment knob extends up to an upper end of the needle portion; and
a tapered member disposed in the second bypass passage in parallel to the needle portion, wherein the tapered member is tapered so that a degree of opening and closing of the needle portion is adjusted.

7. The shock absorber as claimed in any one of claims 1, further comprising:
a buffer spring between the outer cylinder and the rod; and
a lower spring sheet on the outer cylinder, wherein a height of the lower spring sheet is adjustable to support the buffer spring.

8. The shock absorber as claimed in any one of claims 2, further comprising:
a buffer spring between the outer cylinder and the rod; and
a lower spring sheet on the outer cylinder, wherein a height of the lower spring sheet is adjustable to support the buffer spring.

9. The shock absorber as claimed in any one of claims 3, further comprising:
a buffer spring between the outer cylinder and the rod; and
a lower spring sheet on the outer cylinder, wherein a height of the lower spring sheet is adjustable to support the buffer spring.

10. The shock absorber as claimed in any one of claims 4, further comprising:
a buffer spring between the outer cylinder and the rod; and
a lower spring sheet on the outer cylinder, wherein a height of the lower spring sheet is adjustable to support the buffer spring.

11. The shock absorber as claimed in any one of claims 5, further comprising:
a buffer spring between the outer cylinder and the rod; and
a lower spring sheet on the outer cylinder, wherein a height of the lower spring sheet is adjustable to support the buffer spring.

12. The shock absorber as claimed in any one of claims 6, further comprising:
a buffer spring between the outer cylinder and the rod; and
a lower spring sheet on the outer cylinder, wherein a height of the lower spring sheet is adjustable to support the buffer spring.

13. The shock absorber as claimed in claim 7, wherein the lower spring sheet is screwed to the outer cylinder.

14. The shock absorber as claimed in claim 8, wherein the lower spring sheet is screwed to the outer cylinder.

15. The shock absorber as claimed in claim 9, wherein the lower spring sheet is screwed to the outer cylinder.

16. The shock absorber as claimed in claim 10, wherein the lower spring sheet is screwed to the outer cylinder.

17. The shock absorber as claimed in claim 11, wherein the lower spring sheet is screwed to the outer cylinder.

18. The shock absorber as claimed in claim 12, wherein the lower spring sheet is screwed to the outer cylinder.

19. The shock absorber as claimed in claim 7, wherein the lower spring sheet is detachably disposed on the outer cylinder.

20. A shock absorber comprising:
a cylinder casing having an inner cylinder and an outer cylinder arranged at an outside of the inner cylinder;
an upper cap and a lower cap closing upper and lower portions, respectively, of the cylinder casing, wherein a compression damping force control means is mounted on the lower cap;
a bottom valve body disposed on the lower cap, wherein the bottom valve body is configured so that a working fluid flows between the inner cylinder and the outer cylinder via a first passage when a compression operation is performed and via a second passage when an extension operation is performed and configured so that a damping force is adjusted by the compression damping force control means through a first bypass passage formed in a center of the bottom valve body;
a rod airtightly inserted into the upper cap, wherein an end of the rod is extended into the inner cylinder; and
a piston valve body that is disposed on an end of the rod and faces the bottom valve body, wherein the piston valve body having a second bypass passage that connects an upper chamber and a lower chamber included in the inner cylinder with each other, wherein the piston valve body determines a flow direction of the working fluid between the upper chamber and the lower chamber when the rod is expanded and contracted, and wherein the rod includes in a length direction a tensile strength adjustment means that adjusts a degree of opening and shutting of the second bypass passage.
